(19) United States
(12) Patent Application Publication
(10) Pub. No.: US 2018/0068353 A1
(43) Pub. Date: Mar. 8, 2018

(54) SOCIAL MEDIA BROADCAST SYSTEM AND METHOD

(71) Applicant: PINPUT LLC, Gilbert, AZ (US)

(72) Inventors: Christopher A. Dengler, Queen Creek, AZ (US); Cameron J. Normoyle, Gilbert, AZ (US)

(21) Appl. No.: 15/649,593

(22) Filed: Jul. 13, 2017

Related U.S. Application Data
(60) Provisional application No. 62/361,632, filed on Jul. 13, 2016.

(51) Int. Cl. G06Q 30/02; H04H 60/82; H04H 60/80; G06Q 50/00

(52) U.S. Cl. CPC G06Q 30/0277; H04H 60/82; G06Q 50/01; G06Q 30/0252; H04H 60/80

(57) ABSTRACT

Systems and method of the present invention are directed to automated social media broadcast systems and methods. Methods, and computer programs or software application systems are adapted to read and process data from a data source to automatically populate broadcasts to social media accounts, such as Twitter™, Facebook™, YouTube™, LinkedIn™, and the like.

### PRIORITY

This Application claims priority to and the benefit of U.S. Provisional Patent Application No. 62/361,632, which is fully incorporated herein by reference.

### TECHNICAL FIELD

The present invention relates generally to systems, methods, and computer programs for obtaining data from a data source to automatically populate broadcasts to social media services.

### BACKGROUND OF THE INVENTION

Current social media services, such as Twitter™, Facebook™, and LinkedIn™ are widely used by individuals and companies to communicate with friends and customers. Companies often use these services to make announcements and to advertise products, inventory, and sales opportunities.

Conventional promotions by companies or individuals on available social network sites simply includes manually posting information to their customers. This may include identifying current sales, product details, available inventory information, and the like. While these means of reaching customers or advertising can sometimes prove successful, there are inherent drawbacks. Namely, it requires the company, or agents of the company, to be active and diligent in updating customers with timely and informative social media broadcasts. The details of the advertising information must be deliberately pulled together and broadcasted or posted. Advertising details can be overlooked or omitted, and the timing of the manual broadcast push can be less than ideal in reaching the right consumers at the right time.

Accordingly, there exists a need for new, improved, and more efficient systems and methods for broadcasting or posting data sources to social media services.

### SUMMARY OF THE INVENTION

Particular embodiments of the present invention are directed to automatic social media broadcasting systems and methods. The present invention makes it possible for individuals and businesses to tie inventory, products, or general items of interest in a data store to automatic social media broadcasting systems.

The above and other aspects and embodiments of the present invention are described below with reference to the accompanying drawings.

### BRIEF DESCRIPTION OF THE DRAWINGS

The accompanying drawings, which are incorporated herein and form part of the specification, illustrate various embodiments of the present disclosure and, together with the description, further explain the principles of the disclosure and to enable a person skilled in the pertinent art to make and use the embodiments disclosed herein. In the drawings, like reference numbers indicate identical or functionally similar elements.

FIGS. 1-2 show exemplary hardware architecture configurations, in accordance with embodiments of the present invention.

FIGS. 3-4 show data query, processing, and broadcasting methods and steps, in accordance with embodiments of the present invention.

### DETAILED DESCRIPTION

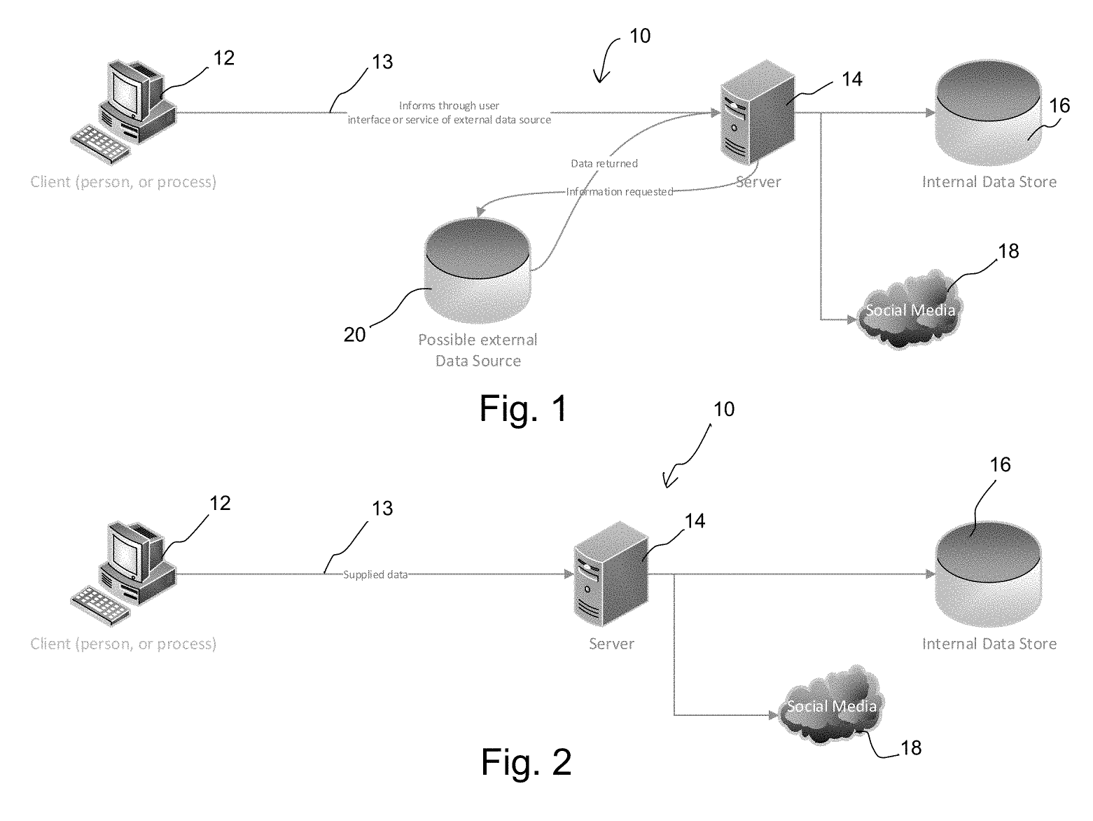

Referring generally to FIGS. 1-4, exemplary methods, and computer programs, or software application systems 100, 200 are adapted to read and process data from a data source to automatically populate broadcasts or posts to social media accounts, such as Twitter™, Facebook™, YouTube™, LinkedIn™, and the like.

Current social media services have an Application Programming Interface (API) that provides third-party developers with the tools to develop software that can interact with and use features of the services. Similarly, third-party developers can have the software and tools to gain authorized and authenticated access to the accounts of fourth parties (e.g., companies or individuals—the user party) such that the third-party developers can selectively broadcast to those accounts on behalf of the fourth party. The present invention provides the programs and methods for automatically generating and publishing these posts based on data and information stored in the aforementioned data source.

FIGS. 1 and 2 show exemplary embodiments of architecture arrangements 10 used in providing and processing the software systems 100, 200 of the present invention. For instance, the arrangement 10 can include one or more client devices 12, one or more servers 14, with a network 13 (e.g., the Internet) provided to link the devices 12 and servers 14. One or more internal data stores 16 are provided in operative communication with at least the server 14. The data stores 16 can be in the form of an electronic database, web service, RSS feed, XML file, or a myriad of other known and electronically organized and readable data formats. FIG. 1 depicts an architecture scheme 10 including an internal data store 16 as well as an external data source 20. One or more social media accounts or services 18 are operatively connected to, or in operative communication with, the server 14 and the data store 16, as detailed further herein. Other hardware and software configurations for carrying out the disclosed methods and processes can be implemented without deviating from the spirit and scope of the present invention. Further, reference to data stores herein can include the internal and/or the external data stores.

In various embodiments, the above-referenced third-party software and processes can occur on server 14, the user's business or individual data can come from client 12, and the data and information from the client 12 can be stored on and processed from the internal data source 16 and/or the external data source 20 for automated and scheduled broadcasting to the user's social media account 18. Data and other information can be written to, stored at, and read from the clients 12, servers 14, and data stores 16, 20 by the systems 100, 200.

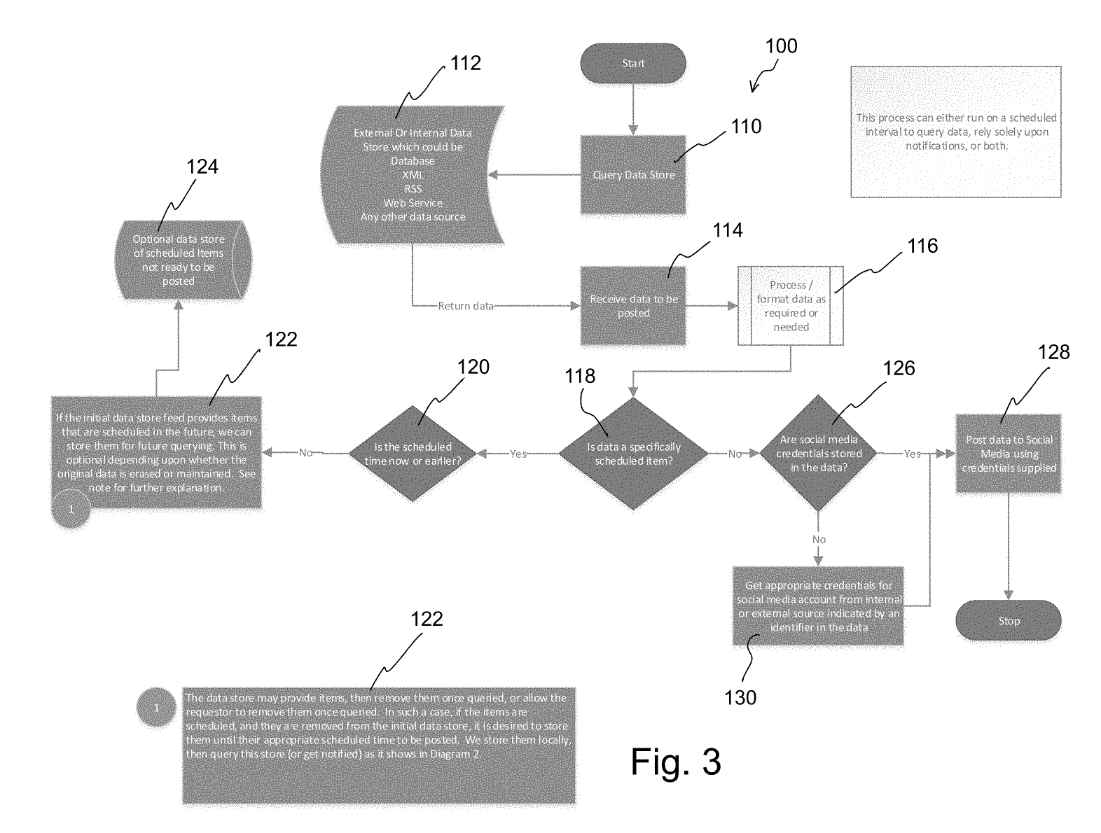

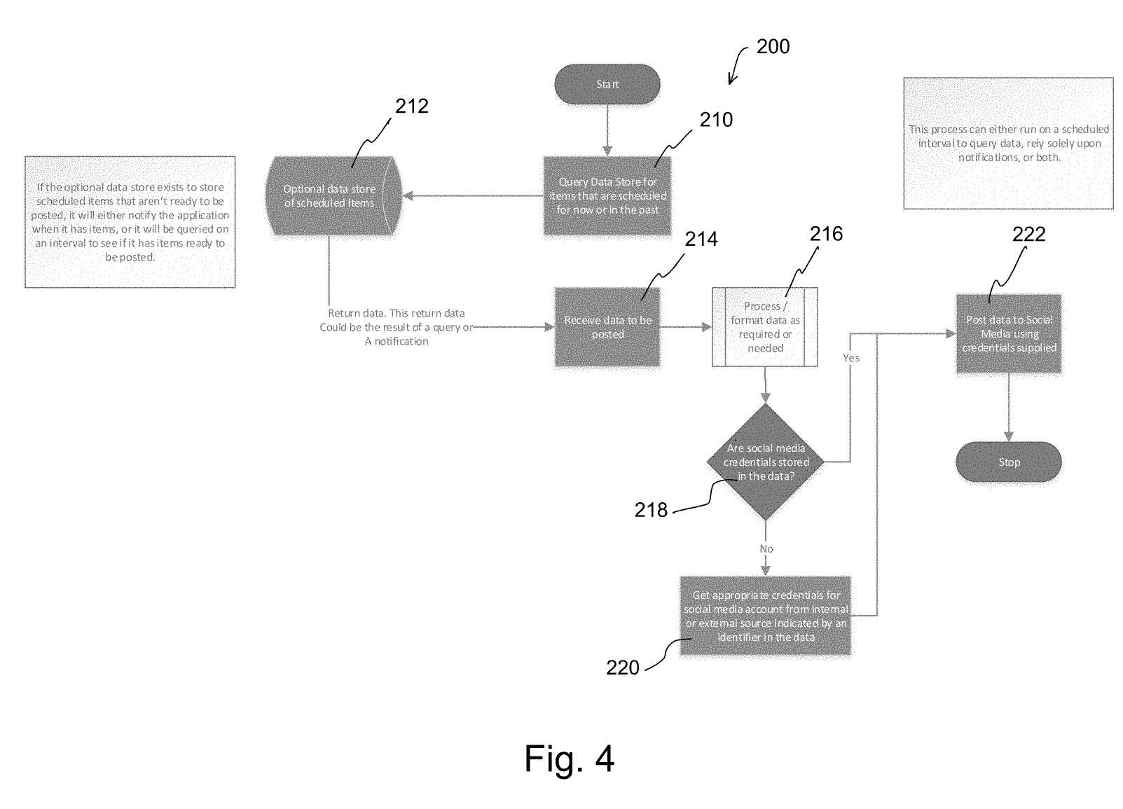

Referring to FIGS. 3-4, exemplary method steps of the present invention are detailed. In FIG. 3 the system 100 queries data at step 110 from external or internal data stores, such as an electronic database, XML files, RSS feeds, web services, or other available data format and sources (step 112). The queries described herein can occur on scheduled intervals (seconds, minutes, hours, days, etc.), trigger based on a notification, or rely on both scheduled and notification processes. The queried data is then received, and can be stored, for processing and posting or broadcasting at step 114. The received data is processed and formatted as needed at step 116—e.g., for proper presentation and/or format requirements for the particular social media account posting. The data can include text, images, videos, and other information and data adapted for, or formatted for, posting to one or more of the respective social media accounts.

Next, the data received for posting is processed to determine if the data is for a specifically scheduled item at step 118. If yes, it is determined whether the scheduled posting time is for another time (step 120). If no, then the system 100 proceeds to verifying and preparing the data items for posting via one or more of a user's social media accounts. First, a determination can be made as to whether the user's account credentials are stored in the received data at step 126. This step can be processed at one or more of the servers or at one or more of the client systems by accessing credentials stored or otherwise provided at the corresponding system. If so, the required login and posting requirements are available, and the system 100 can automatically log in or connect to the social media account, extract and manipulate the data, and broadcast the data to the social media account (step 128). If the credentials are not provided with the data, the system 100 can query and process additional data from the internal or external source to obtain the subject credentials.

Referring to step 118, if the system 100 processes and determines that the data posting is to be scheduled then the data items can be stored for future querying, processing, and posting (step 122). This optional data store of scheduled items for later posts takes place at step 124. As detailed at step 122, the data store may provide items for processing, then remove or delete the items once they are queried, or allow the requestor to remove or delete the items once queried. If the items are scheduled, and removed from the initial data store, the items are stored until the scheduled posting time. At the time of the scheduled posting, the system 100 can proceed with the item posting in accordance with process steps 126 and 128.

Referring to FIG. 4, the system 200 queries data at step 210 from the optional data store of scheduled items (step 212). Again, the data can be provided in an electronic database, XML files, RSS feeds, web services, or other available data format and sources. The queried data is then returned (as a result of a query or based on a received notification) and received at step 214 for processing and posting to one or more of the user's social media accounts. As with the system 100 process, the received data is processed and formatted as needed at step 216. First, a determination is made as to whether the user's account credentials are stored in the received data at step 218. If so, the required login and posting requirements are available, and the system 200 can automatically broadcast the data to the social media account (step 222). If the credentials are not provided with the data, the system 200 can query and process additional data from the internal or external source to obtain the subject credentials. With such scheduling embodiments of the present invention, if the optional data store exists to store scheduled items for posting, a notification can be provided to the software when the items are available, or the data store will be periodically queried to determine if the items are ready for posting based on availability and the defined schedule.

The following is an example of the systems and processes of the present invention used to obtain, process, and post information relative to the advertising and sales of vehicles in the inventory of a car dealership (user). It is noted that this is just an example of the present invention in use and is not intended in any way to limit the application to any particular field, areas of advertising, commercial products or services, data types, etc. Other applications and data examples can include real estate property listings (square footage, price, year built, condition, room numbers, etc.), retail store inventory (product, price, features, etc.), service industry details and information, content creator data and information, to name just a few.

In the provided example, the car dealership can store details of its vehicle inventory in an electronic database—e.g., at the client 12. Data within that database can include a vehicle's make, model, year, a description of the condition and features/options, a photo of the vehicle, the time the vehicle has been in inventory, price adjustments or drops over time, and a myriad of other general and specific data points for each vehicle. Queries from the systems 100, 200 at any given time can process and retrieve data on specific vehicles, based on specific criteria. Moreover, the received data from the query can then be processed for automatic and scheduled (e.g., specific day and time) posting on the car dealership's social media account(s) without requiring the dealership to actually pull together or post the item itself. For instance, the user (car dealership) can indicate that certain inventory items are to be posted on certain days of the weeks, and each post can be based on a different query criteria and corresponding inventory data (e.g., new vehicle inventory, stale inventory, off-road vehicles, etc.).

The present invention makes it possible for individuals and businesses to tie their inventory, products, or general items/information of interest in a data store to the automatic social media broadcasting systems 100, 200.

Various devices or computing systems or servers can be included and adapted to process and carry out the aspects, computations, and algorithmic processing of the systems 100, 200 of the present invention. Computing systems and devices of the present invention may include a processor, which may include one or more microprocessors and/or one or more circuits, such as an application specific integrated circuit (ASIC), field-programmable gate arrays (FPGAs), etc. Further, the devices and systems can include a network interface. The network interface is configured to enable communication with the network 13, other devices and systems, and servers, using a wired and/or wireless connection.

The devices or computing systems may include memory, such as non-transitive memory, which may include one or more non-volatile storage devices and/or one or more volatile storage devices (e.g., random access memory (RAM)). In instances where the devices or computing systems include a microprocessor, computer readable program code may be stored in a computer readable medium or memory, such as, but not limited to magnetic media (e.g., a hard disk), optical media (e.g., a OVO), memory devices (e.g., random access memory, flash memory), etc. The computer program or software code can be stored on a tangible, or non-transitive, machine-readable medium or memory. In some embodiments, computer readable program code is configured such that when executed by a processor, the code causes the device to perform the steps described above and herein. In other embodiments, the device is configured to perform steps described herein without the need for code.

It will be recognized by one skilled in the art that these operations, algorithms, logic, method steps, routines, sub-routines, and modules may be implemented in software, in firmware, in special purpose digital logic, and any combination thereof without deviating from the spirit and scope of the present invention as recited within the disclosure and the claims attached hereto.

The computing devices 12 may include an input device. The input device is configured to receive an input from either a user (e.g., admin, user, etc.) or a hardware or software component—as disclosed herein in connection with the various user interfaces or automatic data inputs. Examples of an input device include a keyboard, mouse, microphone, touch screen and software enabling interaction with a touch screen, etc. The devices 12 can also include an output device. Examples of output devices include monitors, televisions, mobile device screens, tablet screens, speakers, remote screens, etc. The output device can be configured to display images, media files, text, or video, or play audio to a user through speaker output.

Server processing systems 14, for use or connected with the systems 100, 200 of the present invention, can include one or more microprocessors, and/or one or more circuits, such as an application specific integrated circuit (ASIC), field-programmable gate arrays (FPGAs), etc. A network interface can be configured to enable communication with the network 13, using a wired and/or wireless connection, including communication with devices or computing devices disclosed herein. Memory can include one or more non-volatile storage devices and/or one or more volatile storage devices (e.g., random access memory (RAM)). In instances where the server system includes a microprocessor, computer readable program code may be stored in a computer readable medium, such as, but not limited to magnetic media (e.g., a hard disk), optical media (e.g., a DVD), memory devices, etc.

The present invention can be embodied as software code residing on a user's computing device 12 (e.g., desktop, tablet, mobile device, and the like) and/or on the server 14. The various data of the present invention can be included on and transferred to and from a storage area network (SAN), a data cloud, or any computing or storage device for storing the file or files being uploaded, downloaded, or processed.

Aspects of the software code of the invention can take the form of a plugin or app, and can interface with various protocols or software using APIs or other means of interacting with computing software and systems.

While various embodiments have been described above, it should be understood that they have been presented by way of example only, and not limitation. Thus, the breadth and scope of the present disclosure should not be limited by any of the above-described exemplary embodiments. Moreover, any combination of the above-described elements in all possible variations thereof is encompassed by the disclosure unless otherwise indicated herein or otherwise clearly contradicted by context.

While the methods, steps, and processing described above and illustrated in the drawings are shown as a sequence of steps, this was done solely for the sake of illustration. Accordingly, it is contemplated that some steps may be added, some steps may be omitted, the order of steps may be re-arranged, and some steps may be performed in parallel.

It will be readily apparent to those of ordinary skill in the art that many modifications and equivalent arrangements can be made thereof without departing from the spirit and scope of the present disclosure, such scope to be accorded the broadest interpretation of the appended claims so as to encompass all equivalent structures and products.

For purposes of interpreting the claims for the present invention, it is expressly intended that the provisions of 35 U.S.C. §112(f) are not to be invoked unless the specific terms “means for” or “step for” are recited in a claim.

What is claimed is:

1. A method for broadcasting to social media, comprising:
providing a data store having one or more data items;
querying the data store by one or more broadcasting servers for one or more data items;
processing the one or more data items at the one or more broadcasting servers;
determining if the one or more data items includes social media credentials for at least one user; and
broadcasting, from the one or more broadcasting servers, one or more broadcasting data results to at least one social media account for the at least one user, based on the one or more data items.

2. The method of claim 1, further including determining a scheduled time for broadcasting the one or more broadcasting results.

3. The method of claim 1, further including obtaining the social media credentials from the data store.

4. The method of claim 1, wherein the data store is internal to the one or more broadcasting servers.

5. The method of claim 1, wherein the data store is remote to the one or more broadcasting servers.

6. The method of claim 1, further including removing the one or more data items from the data store after querying the data store.

7. The method of claim 6, further including storing the one or more data items after querying the data store.

8. The method of claim 1, wherein the one or more data items includes user inventory data.

9. The method of claim 1, further including formatting the one or more data items for broadcasting to the at least one social media account.

10. The method of claim 1, wherein broadcasting of the one or more broadcasting data results to the at least one social media account is triggered by schedule data.

11. The method of claim 1, wherein broadcasting of the one or more broadcasting data results to the at least one social media account is triggered by one or more notifications.

12. A system for broadcasting to social media, comprising:
a processor;
a non-transitory memory operatively coupled to the processor;
a data store;
wherein the processor is configured to:
query the data store for one or more data items;
process the one or more data items;
determine if the one or more data items includes social media credentials for at least one user; and
automatically broadcast one or more broadcasting data results to at least one social media account for the at least one user, based on the one or more data items.

13. The system of claim 12, wherein the processor further schedules a time for broadcasting the one or more broadcasting results.

14. The system of claim 12, wherein the processor further includes obtaining the social media credentials from the data store.

15. The system of claim 12, wherein the data store is internal to one or more broadcasting servers.

16. The system of claim 12, wherein the data store is remote to one or more broadcasting servers.

17. The system of claim 12, further including storing the one or more data items after querying the data store.

18. The system of claim 12, wherein the one or more data items includes user inventory data.

19. The system of claim 12, further including formatting the one or more data items for broadcasting to the at least one social media account.

20. The system of claim 12, wherein broadcasting of the one or more broadcasting data results to the at least one social media account is triggered by schedule data or by one or more notifications.
